(19) United States
(12) Patent Application Publication
(10) Pub. No.: US 2021/0276198 A1
(43) Pub. Date: Sep. 9, 2021

(54) VERIFYING ROBOT OPERATOR IDENTITY

(71) Applicant: Hewlett-Packard Development Company, L.P., Spring, TX (US)

(72) Inventors: Kevin R. Puttbrese, Corvallis, OR (US); Stephen F. Froelich, Corvallis, OR (US); William J. Allen, Corvallis, OR (US)

(73) Assignee: Hewlett-Packard Development Company, L.P., Spring, TX (US)

(21) Appl. No.: 17/049,051

(22) PCT Filed: Jun. 11, 2018
(86) PCT No.: PCT/US2018/036845

§ 371 Date: Oct. 20, 2020

(51) Int. Cl. B25J 11/00; B25J 9/16; G05D 1/00; H04L 29/06

(52) U.S. Cl. CPC B25J 11/0005; B25J 9/1689; B25J 9/162; G05D 2201/0211; H04L 63/0807; G05D 1/0022; G05D 1/0016

(57) ABSTRACT

An example apparatus includes: a network interface to communicate with: a first display integrated with a robot device; and a second display at a location of a meeting; a memory identifying: a start time of the meeting; and the location of the meeting; and a processor connected to the network interface and the memory, the processor to execute instructions stored in the memory, the instructions to: when the robot device is at the location of the meeting, and at the start time, transmit, using the network interface, an identifier associated with the meeting to both the first display integrated with the robot device and the second display at the location of the meeting, thereby causing both the first display and the second display to simultaneously render the identifier.

### BACKGROUND

Telepresence robots are often used by a remote user to interact with other users present at a meeting location. In particular, telepresence robots are becoming an important tool for conducting meetings in business environments, telehealth environments, and the like.

### BRIEF DESCRIPTION OF THE DRAWINGS

Reference will now be made, by way of example only, to the accompanying drawings in which:

FIG. 1 is a block diagram of an example apparatus to verify robot operator identity;

FIG. 2 is a block diagram of an example robot device which includes a first display to verify robot operator identity;

FIG. 3 is a block diagram of an example device which includes a second display to verify robot operator identity;

FIG. 4 is a flowchart of an example of a method to verify robot operator identity;

FIG. 5 is a block diagram of another example apparatus to verify robot operator identity;

FIG. 6 is a schematic view of another example of the apparatus of FIG. 1;

FIG. 7 is a schematic view of another example of the apparatus of FIG. 1; and

FIG. 8 is a schematic view of another example of the apparatus of FIG. 1.

### DETAILED DESCRIPTION

Telepresence robots may be used for identity theft. In particular, telepresence robots may be used in environments where information is sensitive, such as hospitals, business environments, and the like. For example, a telepresence robot may be operated by a malicious user and deployed in a hospital to interact with a patient, where the malicious user may ask the patient for sensitive information via the telepresence robot.

Hence, provided herein is an apparatus which provides an identifier to both a display of a robot device and a display at a location of a meeting at which a robot device is to participate. The display of the robot device and the display at the location of the meeting both simultaneously render the same identifier, letting a person at the meeting location know that the robot device is authorized to be at the meeting and/or that the user operating the robot device is verified to be at the meeting. The robot device may also be provided with an image of the operator of the robot device, for example in form of a name badge, that the person at the meeting location may compare with a live image of the operator to visually verify that the operator of the robot device is the same as the person in the image.

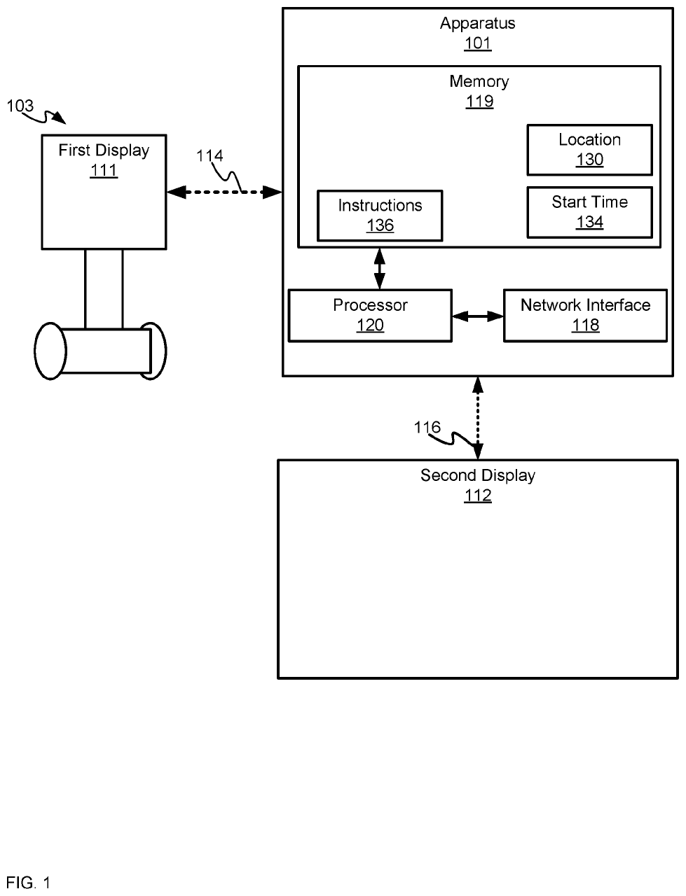

Referring to FIG. 1, an apparatus 101 to verify robot operator identity is depicted. The apparatus 101 may include additional components, such as various additional interfaces and/or input/output devices such as displays to interact with a user or an administrator of the apparatus 101. The apparatus 101 is to verify robot operator identity, such as to verify a user and/or an operator of a robot device 103 that includes a first display 111 integrated with the robot device 103, for example to a user of a second display 112 at a location of a meeting. Such a meeting, as understood by a person of skill in the art, may comprise any type of meeting, appointment, encounter, and the like, including, but not limited to, one or more of a calendared meeting and/or a calendared appointment and/or a calendared encounter, a scheduled meeting and/or a scheduled appointment and/or a scheduled encounter, and the like. Hence, the apparatus 101 may be an authentication server and/or a cloud based device to verify identity of an operator of the robot device 103. The apparatus 101 communicates with the first display 111 and the second display 112 via respective connections 114, 116. Each of the first display 111 and the second display 112 may each include one or more of a liquid crystal display (LCD), an organic light emitting display (OLED), a flat panel display, and the like.

In the present example, the apparatus 101 includes a network interface 118, a memory 119, and a processor 120. The processor 120 is connected to the network interface 118 and the memory 119. The network interface 118 is to communicate with: the first display 111 integrated with the robot device 103; and the second display 112 at a location of a meeting. The memory 119 includes a location 130 of the meeting including, but not limited to Global Positioning System (GPS) coordinates, WiFi-based coordinates, and the like. The memory 119 may also store a start time 134 of the meeting. While not depicted, the memory 119 may also store one or more of a stop time of the meeting, a duration of the meeting, and the like, as well as any other information related to the meeting.

In some examples, the memory 119 may also store an identifier of the meeting, including, but not limited to one or more of; an alphanumeric identifier of the meeting; an alphanumeric identifier of a room associated with the meeting; a graphic identifier of the meeting; an image of an operator of the robot device 103; and a name badge of the operator of the robot device 103. In some examples, the image of the operator of the robot device 103 and/or the name badge of the operator of the robot device 103 may be different from the identifier of the meeting.

The memory 119 may also store identifiers of the users who are to participate in the meeting and/or registration information of the users who are to participate in the meeting and/or registration information of the robot device 103 that is to participate in the meeting. The identifiers of the users and/or the robot device 103 may include names, images, aliases, and the like.

The memory 119 also store and/or be encoded with instructions 136 executable by the processor 120 to verify robot operator identity. The processor 120 is to execute the instructions 136 stored in the memory 119, the instructions 136 to: when the robot device 103 is at the location 130 of the meeting, and at the start time 134, transmit, using the network interface 118, an identifier associated with the meeting to both the first display 111 integrated with the robot device 103 and the second display 112 at the location 130 of the meeting, thereby causing both the first display 111 and the second display 112 to simultaneously render the identifier.

The network interface 118 is to communicate with a network such as a wired or wireless network which may include one or more of a cellular network, a WiFi network, and the like, the connections 114, 116 being via the network. The network and the connections 114, 116 may be wireless (and/or at least partially wired) as desired.

The memory 119 is coupled to the processor 120 and may include a non-transitory machine-readable storage medium that may be any electronic, magnetic, optical, or other physical storage device. In the present example, the memory 119 stores the location 130 and start time 134 of a meeting, for example in a database and/or a calendar database. The location 130 and start time 134 may be stored in association with a meeting identifier and/or a meeting identifier may be generated, for example by the processor 120.

The non-transitory machine-readable storage medium may include, for example, random access memory (RAM), electrically-erasable programmable read-only memory (EEPROM), flash memory, a storage drive, an optical disc, and the like. The memory 119 may also be encoded with executable instructions to operate the network interface 118 and other hardware in communication with the processor 120. In other examples, it is to be appreciated that the memory 119 may be substituted with a cloud-based storage system.

The memory 119 may also store an operating system that is executable by the processor 120 to provide general functionality to the apparatus 101, for example, functionality to support various applications such as a user interface to access various features of the apparatus 101. Examples of operating systems include Windows™, macOS™, iOS™, Android™, Linux™, and Unix™. The memory 119 may additionally store applications that are executable by the processor 120 to provide specific functionality to the apparatus 101, such as those described in greater detail below and which may include the instructions 136.

The processor 120 may include a central processing unit (CPU), a microcontroller, a microprocessor, a processing core, a field-programmable gate array (FPGA), or similar. The processor 120 and memory 119 may cooperate to execute various instructions such as the instructions 136.

In addition, the apparatus 101 may be to generate an identifier of the meeting, for example a token and the like, such as a token generated for the meeting. The apparatus 101 may be to generate a one-time token fora meeting and/or may be to periodically generate tokens for the duration of the meeting.

Accordingly, the processor 120 may execute instructions stored on the memory 119 to verify robot operator identity for one or more robot devices including the robot device 103. It is to be appreciated that in other examples, a portion of the functionality of the apparatus 101 may be carried out at device, such as a server or machine, or carried out by a virtual machine in the cloud. For example authentication of the users participating in the meeting may be carried out by an authentication device in communication with the apparatus 101; such authentication may occur when the meeting is arranged.

The processor 120 is also to control and/or monitor the network interface 118. For example, the processor 120 is to monitor the location of the robot device 103 via locations that are received via the network interface 118 from the robot device 103.

The processor 120 may also be further to: transmit, using the network interface 118, an image of an operator of the robot device 103 to the first display 111 at the robot device 103, thereby causing the first display 111 at the robot device 103 to render the image of the operator of the robot device 103 with the identifier.

The processor 120 may be further to: for a duration of the meeting, periodically generate a current identifier associated with the meeting and periodically transmit, using the network interface 118, the current identifier to the first display 111 and the second display 112, thereby causing both the first display 111 and the second display 112 to replace rendering of a previous identifier with the current identifier.

In some examples, the processor 120 may be further to generate an identifier and/or a current identifier by generating a token and/or a current token.

In some examples, the processor 120 may be further to receive, from a computing device associated with the second display 112 at the location 130 of the meeting, a confirmation that both the first display 111 and the second display 112 are simultaneously rendering the identifier and/or a current token; and transmit an instruction to the computing device and the robot device 103 to proceed with the meeting.

In some example, the processor 120 may be further to receive, from a computing device associated with the second display 112 at the location of the meeting, a warning that the first display 111 and the second display 112 are not simultaneously rendering the identifier and/or a current token; and transmit an instruction to the computing device and the robot device 103 to not proceed with the meeting.

In some examples, the memory 119 may be further to identify an end time of the meeting; in these examples, the processor 120 may be to: at the end time, transmit, using the network interface 118, an instruction to the first display 111 and the second display 112 to stop rendering of the identifier or a current identifier.

In some examples, the processor 120 may be further to generate a certificate for one or more of users registered to participate in the meeting and/or generate a certificate for the robot device 103. The certificates may be public certificates used to sign data exchanged between the apparatus 101, the robot device 103 and the second display 112, as well as any other components used in such communication of such data. In yet further examples, one or more the certificates may be alphanumeric and/or one or more of the certificates graphical; for example, an alphanumeric certificate may be converted to a graphical certificate by converting the alphanumeric certificate to a barcode, a two-dimensional barcode, a Quick Response (QR) code, and the like. Generation of such certificates may occur after authentication of the users registered to participate, for example by an authentication device.

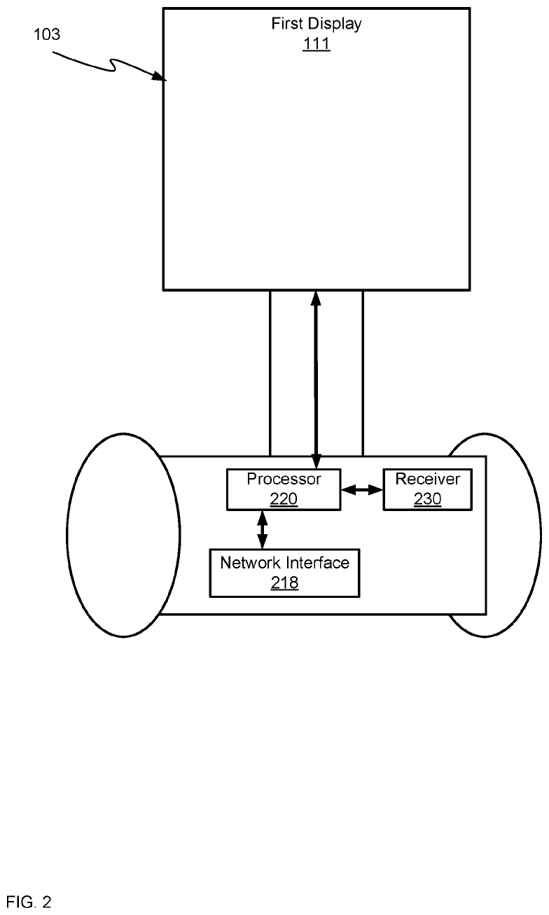

FIG. 2 depicts a schematic block diagram of the robot device 103. The robot device 103 may include additional components, such as various additional interfaces to interact with an operator of the robot device 103 via a robot controller device, as well as robotic components to navigate the robot device 103 using motors, wheels, treadmills and the like. The robot device 103 may be operated via such a robot controller device, which may in turn communicate with a robot service device which communicates with a plurality of robot devices. Accordingly, it is to be assumed that the robot device 103 may generally be operated by a user to navigate the robot device 103 to the location of the second display 112 for a meeting. The robot device 103 may hence include further additional components for navigating, such as obstacle sensors and the like.

For example, the robot device 103 may be telepresence robot and may hence include further additional components, such as various input/output devices to interact with a user of the second display 112 at the location of the meeting; such input/output devices integrated with the robot device 103 include the first display 111, and may further include one or more cameras, one or more microphones, one or more speakers and the like. For example, the robot device 103 may render, at the first display 111, a live image of the operator of the robot device 103 as received from the robot controller device, which may include a camera to capture the live image of the operator of the robot device 103.

In the present example, the robot device 103 includes a network interface 218, a processor 220 and a receiver 230 to determine and/or receive location coordinates, and the like. Alternatively, an environment in which the location of the meeting is to occur may include components for locating the robot device 103 and reporting the location to the apparatus 101.

The receiver 230 is also not particularly limited and is to determine location coordinates for the robot device 130, including, but not limited to, GPS coordinate based on GPS data, local location coordinates based on a WiFi based indoor location system, triangulation coordinates, and the like.

The network interface 218 is to communicate with a network such as a wireless network which may include a cellular network or a local network, such as a Wi-Fi network. In the present example, the network interface 218 is to receive an identifier associated with a meeting for rendering at the first display 111. In addition, the network interface 218 may be to receive an image of an operator of the robot device 103, for example from the apparatus 101, thereby causing the first display 111 at the robot device 103 to render the image of the operator of the robot device 103 with the identifier. The network interface 218 may be further to communicate a location of the robot device 103, as determined using the receiver 230, to the apparatus 101. Communication with the apparatus 101 may at least partially occur via a robot service device.

The processor 220 may include a central processing unit (CPU), a microcontroller, a microprocessor, a processing core, a field-programmable gate array (FPGA), or similar. The processor 220 may be to execute various instructions. In the present example, the processor 220 is to receive an identifier associated with a meeting and control the first display 111 to render the identifier.

The processor 220 is also to control the network interface 218. For example, the processor 220 is to monitor the location received via the receiver 230 and transmit the location to the apparatus 101. Furthermore, the processor 220 is to monitor the network interface 218 for navigation commands received a robot controller device and control the robot device 103 to move and/or navigate according to the navigation commands; the processor 220 may be to implement the navigation commands based at least partially on the location received via the receiver 230.

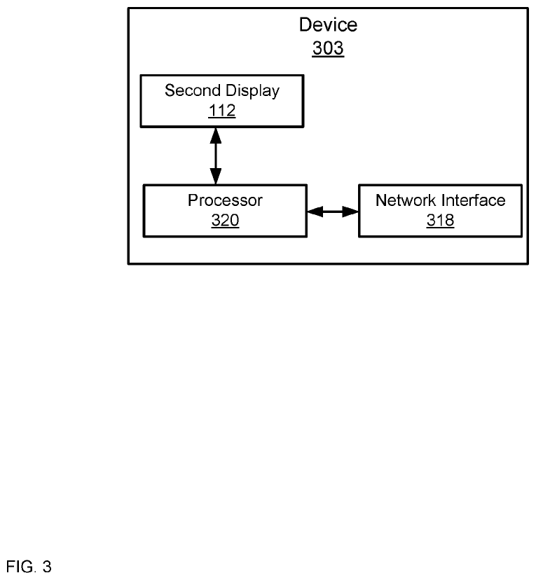

FIG. 3 depicts a schematic block diagram of a device 303 that includes the second display 112. The device 303 may include additional components, such as various additional interfaces and/or input/output devices to interact with a user of the device 303 and/or the second display 112. In some examples, the device 303 may be a fixed device located on a wall, and the like, of the location 130 of a meeting; in such examples, the device 303 may be dedicated to verifying robot operator identity to users at the location 130 of the meeting. In other examples, the device 303 may be mobile device, such as a mobile device of a user that is to meet with the operator of the robot device 103 at the location; in these examples, the device 303 may be a smartphone laptop, smartphone, smartwatch, computer, tablet, or other electronic device that includes a display (e.g. the second display 112), and the functionality of verifying robot operator identify may occur via an application at least partially dedicated to verifying robot operator identify.

The network interface 318 is to communicate with a network such as a wireless network which may include a cellular network or a local network, such as a Wi-Fi network. In the present example, the network interface 318 is to receive an identifier associated with a meeting for rendering at the second display 112. In addition, the network interface 318 may be to receive an image of an operator of the robot device 103, for example from the apparatus 101, thereby causing the second display 112 to render the image of the operator of the robot device 103 with the identifier.

The processor 320 may include a central processing unit (CPU), a microcontroller, a microprocessor, a processing core, a field-programmable gate array (FPGA), or similar. The processor 320 may be to execute various instructions. In the present example, the processor 320 is to receive an identifier associated with a meeting and control the second display 112 to render the identifier. The identifier may include the image of the operator of the robot device 103 with the identifier and/or the processor 320 may be further to render the image of the operator of the robot device 103 at the second display 112 with the identifier

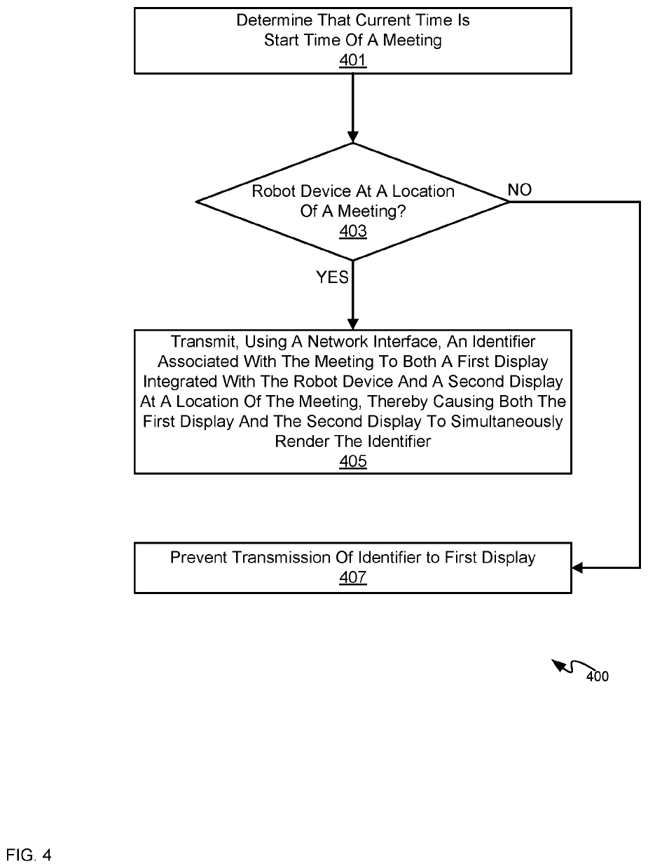

Referring to FIG. 4, a flowchart of a method 400 for verifying robot operator identity is shown. In order to assist in the explanation of method 400, it will be assumed that method 400 may be performed with the apparatus 101, and specifically by the processor 120. Indeed, the method 400 may be one way in which apparatus 101 may be configured to interact with the robot device 103 and the device 303. Furthermore, the following discussion of method 400 may lead to a further understanding of the processor 120, and apparatus 101 and its various components. Furthermore, it is to be emphasized, that method 400 may not be performed in the exact sequence as shown, and various blocks may be performed in parallel rather than in sequence, or in a different sequence altogether.

Beginning at block 401, the processor 120 determines that a current time is the start time 134 of a meeting at the location 130, for example as scheduled between an operator of the robot device 103 and a user who is to be at the location 130 at the start time 134. The processor 120 may implement the block 401 by monitoring a clock device for a current time, for example a clock device of the processor 120 and/or clock device in communication with the processor 120, and comparing to the start time 134. The processor 120 may implement the block 401 repeatedly and/or periodically until the current time is at and/or near the start time 134 (e.g. within a given period of time to the start time 134).

At the block 403, the processor 120 determines whether the robot device 103 is at the location 130 of the meeting. For example, the processor 120 may receive a location of the robot device 103 from the robot device 103 as determined using the receiver 230; alternatively, the processor 120 may communicate with components for locating the robot device 103 which report the location of the robot device 103 to the apparatus 101.

When the robot device 103 is at the location 130 of the meeting, at the start time 134 (e.g. a “YES” decision at the block 403), at a block 405, the processor 120 transmits, using the network interface 118, an identifier associated with the meeting to both the first display 111 integrated with the robot device 103 and the second display 112 at the location of the meeting, thereby causing both the first display 111 and the second display 112 to simultaneously render the identifier.

Hence, as the first display 111 and the second display 112 are both rendering the same identifier, a user at the location 130 may determine that the operator of the robot device 103 has been verified and/or that the robot device 103 is a robot device that is scheduled to participate in the meeting, and not a robot device operated by a malicious user.

In some examples, when the device 303 is portable, and hence the second display 112 is also portable, the processor 120 may also determine the location of the device 303 and implement the block 405 only when the device 303 is also at the location 130 of the meeting. In particular, at the block 403 the processor 220 may alternatively determine whether the robot device 103 and the device 303 are at the location 130 of the meeting and implement the block 405 when the robot device 103 and the device 303 are at the location 130 of the meeting.

In some examples, at the block 405, the processor 120 may further retrieve the identifier from a memory, such as the memory 119. For example, the memory 119 may store the identifier in association with the location 130 and the start time 134.

In some examples, the identifier may be generated from one or more of the certificates of the users scheduled to participate in the meeting and the robot device 103. For example, one or more of the certificates may be concatenated with the start time 134, an end time of the meeting, a date of the meeting, a location of the meeting, and the like. In some examples, the resulting string may be hashed using any suitable hashing algorithm. In some of these examples the hash of the resulting string may be converted to an integer, for example between 0 and 100, and concatenated with the hash of the resulting string. Furthermore, the hash of the resulting string with or without the concatenated integer, may be used as a public certificate, and/or signed by the apparatus 101, and transmitted as the identifier of the meeting.

In other examples, at the block 405, the processor 120 may generate the identifier. In some of these examples the identifier may comprise a token generated for the meeting including, but not limited to, a one-time token. The token may comprise one or more of: an alphanumeric identifier of the meeting; the alphanumeric identifier added to a prefix string or a suffix strong; and a graphic identifier of the meeting. However, suitable scheme for generating an identifier of the meeting is within the scope of the present specification including, but not limited to, generating random numbers to identify the meeting.

In some of these example, the identifier, such as a token, may be generated periodically for the duration of the meeting. For example, the processor 120 may periodically generate a current identifier associated with the meeting, such as another token and/or a current token, and periodically transmit, using the network interface 118, the current identifier to the first display 111 and the second display 112, thereby causing both the first display 111 and the second display 112 to replace rendering of a previous identifier with the current identifier. the current token may comprise one or more of: an alphanumeric identifier of the meeting; the alphanumeric identifier added to a prefix string or a suffix strong; and a graphic identifier of the meeting. Hence, for the duration of the meeting, the identifier is periodically updated at the first display 111 and the second display 112 such that the user at the location 130 may periodically determine that the operator of the robot device 103 has been periodically verified and/or that the robot device 103 is a robot device that is scheduled to participate in the meeting, and not a robot device operated by a malicious user.

In some examples, the identifier of the meeting may include more than one identifier, for example a combination of the hash of the resulting string (with or without the concatenated integer) and a token and/or a current token.

In some examples, at the block 405, the processor 120, when the identifier of the meeting does not include an image of the operator of the robot device 103, the processor 120 may also transmit, using the network interface 118, an image of an operator of the robot device 103 to the first display 111 at the robot device 103, thereby causing the first display 111 at the robot device 103 to render the image of the operator of the robot device 103 with the identifier of the meeting. In some of these examples, the first display 111 at the robot device 103 may render the image of the operator of the robot device 103 with a token and/or a current token. Hence, the user at the location 130 interacting with the robot device 103 may compare a live image of the operator of the robot device 103 with the image of the operator of the robot device 103 transmitted by the apparatus 101 as an additional verification of the operator of the robot device 103.

In some examples, at an end time of the meeting, the processor 120: at the end time, transmits, using the network interface 118, an instruction to the first display 111 and the second display 112 to stop rendering of the identifier or a current identifier. Hence, the user at the location 130 may determine that the meeting has ended and/or that the operator of the robot device 103 is no longer verified to participate in the meeting.

Returning to the block 403, with the robot device 103 is not at the location 130, of the meeting (e.g. a “NO” decision at the block 403), at a block 407 the apparatus 101 prevents transmission of the identifier of the meeting to the first display 111. Hence, the first display 111 of the robot device 103 does not render the identifier and if another robot device arrives at the location 130 for the start time 134, the user at the location 130 may determine that the other robot device is a robot device that is not scheduled to participate in the meeting, and/or the user at the location may determine that the other robot device is operated by a malicious user.

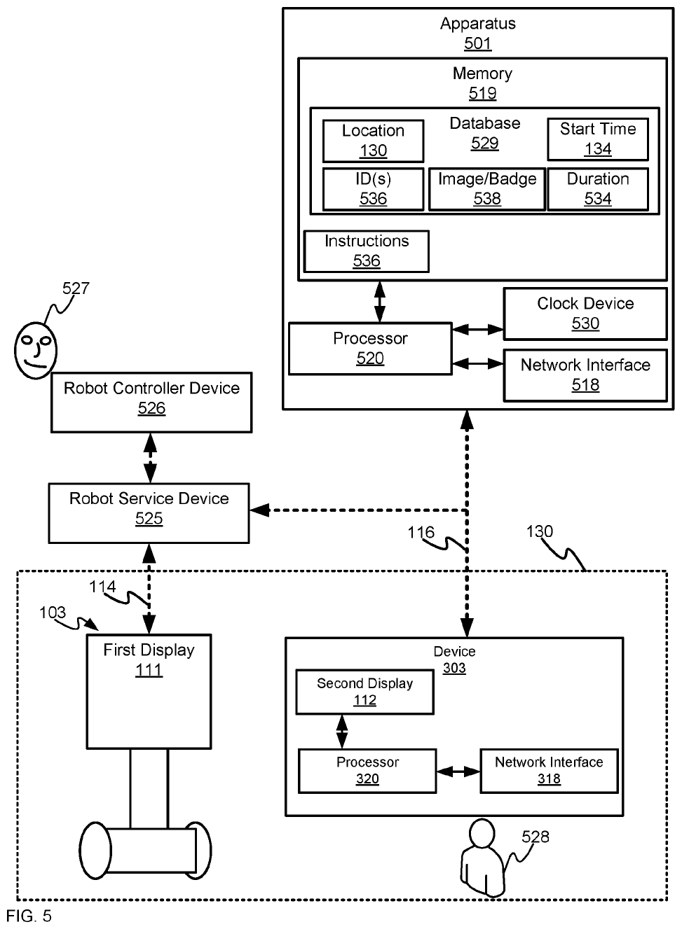

Referring now to FIG. 5, another example of an apparatus 501 to handle print jobs across a network is depicted. Like components of the apparatus 501 bear like reference to their counterparts in the apparatus 101, except in a “500” series rather than in a “100” series. Furthermore, the apparatus 501 may include all the functionality of the apparatus 101 as described above. The apparatus 501 includes a network interface 518, a memory 519, and a processor 520. The processor 520 may be to carry out a set of instructions 536 to operate the apparatus 501, in general. In addition, the apparatus 501 may be connected to the robot device 103 and the device 303 via the connections 114, 116, respectively and/or, as depicted, via a robot service device 525. Accordingly, the apparatus 501 is another example that may be used to carry out the method 400.

The network interface 518 is to communicate with a network, such as a wireless network, and may communicate with the robot device 103 via the robot service device 525, and may further communicate with a robot controller device 526 via the robot service device 525. The robot controller device 526 may be used by a operator 527 to control the robot device 103 via the robot service device 525. For example, the operator 527 may operate the robot controller device 526 to transmit signals to the robot device 103 to navigate to the location 130 of the meeting to meet, via the robot device 103, with a user 528 at the location 130.

The memory 519 is coupled to the processor 520 and may include a non-transitory machine-readable storage medium that may be any electronic, magnetic, optical, or other physical storage device. In the present example, the memory 519 stores a database 529 that includes the location 130 of the meeting, the start time 134 of the meeting, a duration 534 of the meeting, identifier(s) 536 of the participants in the meeting, such as the operator 527 and the user 528 (and/or an identifier of the robot device 103), and an image 538 of the operator 527 (which may include, but is not limited to, an image of a badge of the operator 527).

As depicted, the apparatus 501 further comprises a clock device 530 which may be used by the processor 520 to determine a current time.

The non-transitory machine-readable storage medium may include, for example, random access memory (RAM), electrically-erasable programmable read-only memory (EEPROM), flash memory, a storage drive, an optical disc, and the like. The memory 519 may also be encoded with executable instructions to operate the network interface 518 and other hardware, such as various input and output devices like a monitor, keyboard or pointing device to allow a user or administrator to operate the apparatus 501.

The memory 519 may also store an operating system that is executable by the processor 520 to provide general functionality to the apparatus 501, for example, functionality to support various applications such as a user interface to access various features of the apparatus 501. Examples of operating systems include Windows™, macOS™, iOS™, Android™, Linux™, and Unix™. The memory 519 may additionally store applications that are executable by the processor 520 to provide specific functionality to the apparatus 501.

Although the present example illustrates one database 529, it is to be appreciated that the memory 519 is not particularly limited and that additional databases may be maintained to store additional data, such data for authentication of the operator 527 and the user 528, and the like. In addition, an organization may have devices connected via various networks which may have different levels of security protocols. Accordingly, each group of devices connected to a single network may have information stored in a separate database. Similarly, the database 529 may store data for multiple meetings; hence, the database 529 may comprise a calendaring database.

The processor 520 may include a central processing unit (CPU), a microcontroller, a microprocessor, a processing core, a field-programmable gate array (FPGA), or similar. The processor 520 and memory 519 may cooperate to execute various instructions.

The processor 520 and/or the instructions 536 are generally to: when the robot device 103 is at the location of the meeting, and when the meeting begins, for the duration of the meeting: periodically generate a current token for the meeting; and transmit, using the network interface 518, the current token to both the first display 111 integrated with the robot device 103 and the second display 112 at the location 130 of the meeting thereby causing both the first display 111 and the second display 112 to one or more of: render the current token; and replace rendering of a previous token with the current token.

The current token may comprise one or more of: an alphanumeric identifier of the meeting; the alphanumeric identifier added to a prefix string or a suffix strong; and a graphic identifier of the meeting, as described above.

The processor 520 may be further to: transmit, using the network interface 518, the image 538 of the operator 527 of the robot device 103 to the first display 111 at the robot device 103, thereby causing the first display 111 at the robot device 103 to render the image 538 of the operator 527 of the robot device 103 with the current token.

The processor 520 may be further to: receive, from a computing device (e.g. the device 303) associated with the second display 112 at the location 130 of the meeting, a confirmation that both the first display 111 and the second display 112 are simultaneously rendering the current token; and transmit an instruction to the computing device and the robot device 103 to proceed with the meeting.

The processor 520 may be further to: receive, from a computing device (e.g. the device 303) associated with the second display 112 at the location 130 of the meeting, a warning that the first display 111 and the second display 112 are not simultaneously rendering the current token; and transmit an instruction to the computing device and the robot device 103 to not proceed with the meeting.

The robot service device 525 may further be to communicate with a plurality of robot devices, including the robot device 103, and to assign a robot device to the operator 527 for use in a meeting. For example, when a meeting is scheduled, the operator 527 and the user 528 may register for a meeting, for example via respective calendaring applications of respective devices operated by the operator 527 and the user 528; an authentication device (not depicted) may authenticate each of the operator 527 and the user 528; and the robot service device 525 may assign the robot device 103 to the operator 527 for use during the meeting. In such examples the apparatus 501, the robot service device 525 and any authentication device may communicate and/or cooperate to schedule the meeting and store data for the meeting in the database 529.

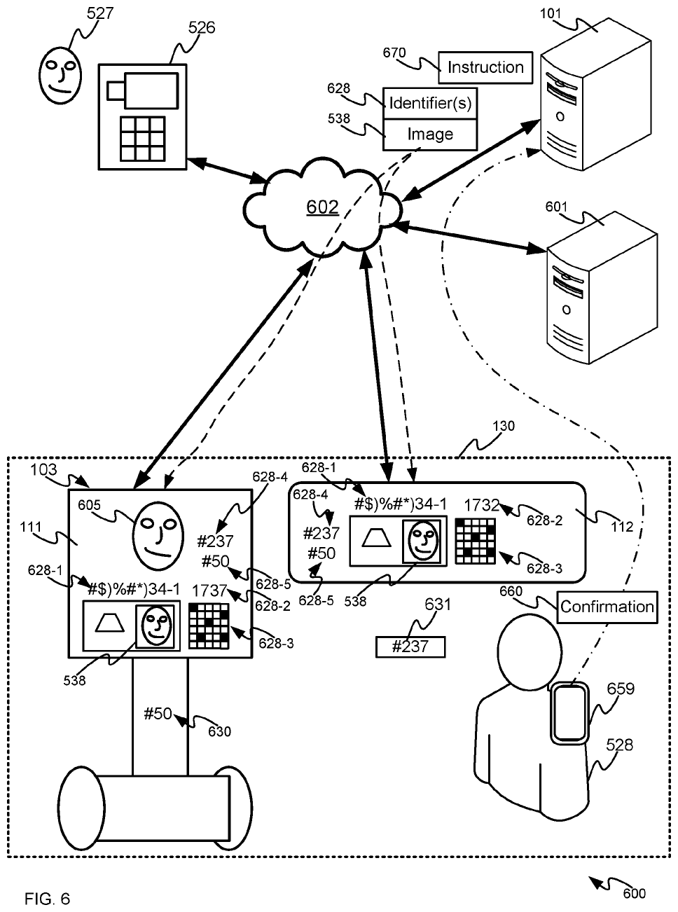

Referring to FIG. 6, a schematic representation of a network system 600 is depicted. The system 600 includes the apparatus 101, the robot device 103 (including the first display 111 integrated with the robot device 103), the second display 112 (which may be a component of the device 303), the robot controller device 526 (which includes a camera and controls for controlling the robot device 103), an authentication device 601, which may be a component of the apparatus 101 or a separate component (as depicted), all interconnected via a network 602. While the robot service device 525 is not depicted, the robot service device 525 may nonetheless be present. Alternatively, the apparatus 101 may be replaced with the apparatus 501.

As depicted, the operator 527 and the user 528 have scheduled a meeting, been authenticated using the authentication device 601, and the robot device 103 has been assigned to the operator 527 for use during the meeting. The data for the meeting may be populated at the memory 119 (and/or the database 529). Furthermore, as depicted, the operator 527 has navigated the robot device 103 to the location 130 for the meeting and the user 528 is also located at the location 130.

It is furthermore understood by persons of skill in the art that the location 130 indicated in FIG. 6 is a physical and/or geographical location, while the location 130 stored in the memory 119 is data indicating the physical and/or geographical location.

It is furthermore understood by persons of skill in the art that the current time is the start time 134 of the meeting, and that the apparatus 101 has determined that the robot device 103 is at the location 130. Hence, in FIG. 6, the meeting is starting.

As further depicted in FIG. 6, the robot controller device 526 is capturing a live image 605 of the operator 527 and the live image 605 is being rendered at the first display 111 integrated with the robot device 103.

Furthermore, the apparatus 101 is transmitting, to the first display 111 and the second display 112, at least one identifier 628 of the meeting and the image 538 of the operator 527. As depicted, the identifier 628 includes: an alphanumeric identifier 628-1, a token 628-2 (such as a current token), a graphical identifier 628-3, a room name and/or number 628-4 (which may match a room name and/or number of the location 130 provided at the location, for example on a sign 631), and an identifier 628-5 of the robot device 103 (e.g. which may match an identifier 630 located on the robot device 103, for example printed on the robot device 103). While five identifiers 628 are depicted, as few as one identifier may be used, or more than five identifiers.

Furthermore, as depicted, the image 538 includes an image of a badge of the operator 527. Hence, as depicted, both the first display and the second display 112 render the identifier 628 and the image 538, which enables the user 528 to determine that the operator 527 of the robot device 103 has been verified.

Furthermore, the user 528 may match the room name and/or number 628-4 rendered at the first display 111 with a room name and/or number at the sign 631 and/or match the identifier 628-5 of the robot device 103, rendered at the second display 112, with the identifier 630 located on the robot device 103. Furthermore, in some examples, the room name and/or number 628-4, when present, may be provided only at the first display 111, and/or the identifier 628-5 of the robot device 103, when present, may be provided only at the second display 112

Furthermore, the user 528 may match the identifier 628-5 of the robot device 103 with the printed identifier 630 on the robot device 103. Furthermore, the user 528 may compare the image 538 rendered at the first display 111 and the second display 112 with the live image 605 and further determine that the that the operator 527 of the robot device 103 has been verified.

As depicted, the user 528 is operating a mobile computing device 659 (which may include the device 303 and/or the second display 112) at the location 130 of the meeting; hence the computing device 659 may be associated with the second display 112 at the location 130. The user 528 may operate the computing device 659 to transmit a confirmation 660 that both the first display 111 and the second display 112 are rendering the same identifier 628 and/or a current token 628-2. The apparatus 101 may then transmit an instruction 670 to the computing device 659 and the robot device 103 to proceed with the meeting; in some examples, the meeting may be locked until the instruction 670 is received, for example audio for the meeting may be muted at the robot device 103 and the robot controller device 526 until the instruction 670 is received. Alternatively, locking the meeting may comprise muting the meeting after a given time period. In some examples, when the confirmation 660 is not received the apparatus 101 may end the meeting, for example, by controlling the robot device 103 (e.g. via the robot service device 525) to stop obtaining audio and/or video of the user 528.

It is further understood by persons of skill in the art that the example of FIG. 6 may be repeated for the duration of the meeting and/or until an end time of the meeting. For example, the token 628-2 may be updated periodically, such that a current token replaces a previous token periodically throughout the duration of the meeting, for example every minute, and the like. When the tokens 628-2 rendered at both the first display 111 and the second display 112 are no longer the same, the user 528 may alert the apparatus 101 by transmitting a warning in a manner similar to transmitting the confirmation 660, which may cause the apparatus 101 to end the meeting.

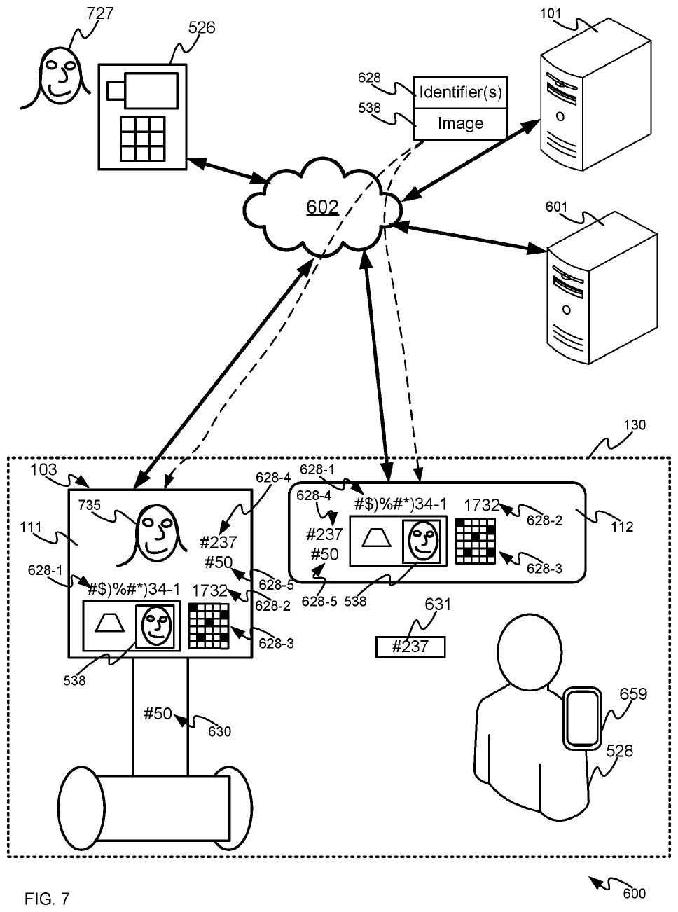

Attention is next directed to FIG. 7 which is substantially similar to FIG. 6 with like elements having like numbers. However, in FIG. 7 an operator 727 different from the operator 527 is operating the robot device 103 via the robot controller device 526; for example, the operator 527 may have scheduled the meeting and later asked the operator 727 to attend in their place (e.g. due to a scheduling conflict and the like). Hence, while the identifier 628 at the first display 111 and the second display 112 are the same, the image 538 at the first display 111 and the second display 112 do not match a live image 735 of the operator 727 at the first display 111. In response, the user 528 and the operator 727 may communicate via the robot device 103 such that the operator 727 may explain their attendance (e.g. due to the scheduling conflict). In these examples the audio is not muted for at least the beginning of the meeting, at least for a given time period, such as the first 5 minutes of the meeting, and the like.

The user 528 may determine that, as the identifiers 628 rendered at the first display 111 and the second display 112 are the same, the operator 727 has been verified regardless of the images 538 not matching the live image 735 and continue with the meeting (e.g. by transmitting the confirmation 660 using the computing device 659). Alternatively, the user 528 may cancel the meeting, for example by using the computing device 659 to transmit a cancellation and/or a warning to the apparatus 101.

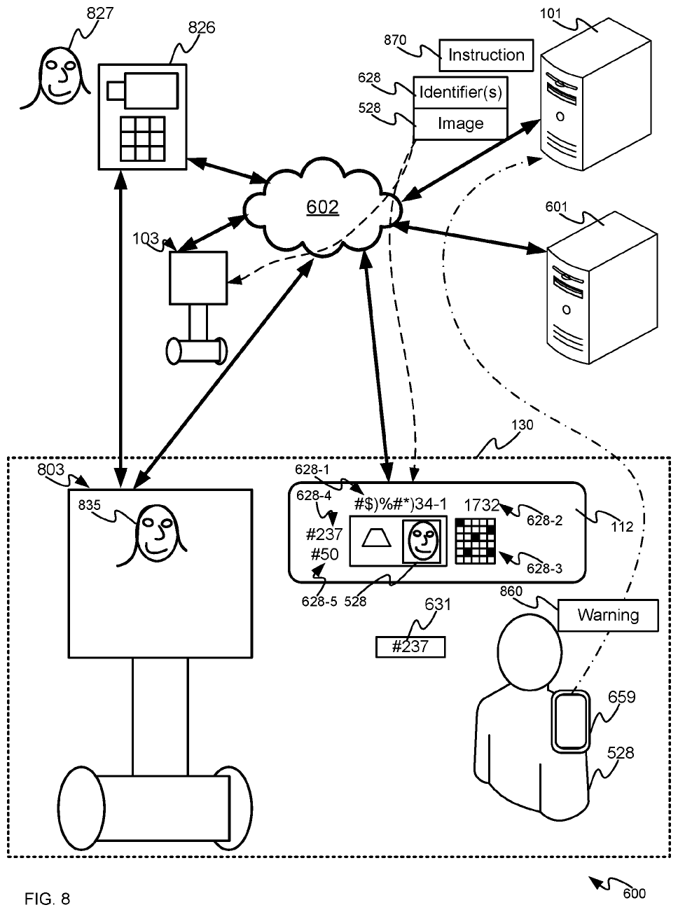

Attention is next directed to FIG. 8 which is substantially similar to FIG. 6 with like elements having like numbers. While the operator 527 and the robot controller device 526 are not depicted, they are nonetheless assumed to be present. In FIG. 8, however, a robot device 803, different from the robot device 103, has been navigated to the location 130 by an operator 827, different from the operator 527, using a robot controller device 826. For example, the robot device 103 may not yet be at the location 130 for the meeting start time 134 and/or the operator 827 may have prevented the robot device 103 from reaching the location 130 and/or the operator 827 may have navigated the robot device 803 to the meeting location 130 to attempt to communicate with the user 528 to steal sensitive information, and the like. Hence, the operator 827 may be a malicious user.

Furthermore, the robot controller device 826 may be in communication with the robot device 803 via the network 602 or, as depicted, the robot controller device 826 may be in communication with the robot device 803 without using the network 602 (e.g. using communication components at each of the robot controller device 826 and the robot device 803).

As also depicted, the apparatus 101 is transmitting the identifier 628 and the image 538 to the second display 112 which is rendering the identifier 628 and the image 538. While the identifier 628 and the image 538 may also be transmitted to the first display 111 integrated with the robot device 103, the identifier 628 and the image 538 is not transmitted to the robot device 803. Hence, the robot device 803 cannot render the identifier 628 and the image 538 at a respective display.

Hence, the user 528 may determine that the operator 827 is not verified to participate in the meeting as the identifier 628 and/or the current token 628-2 and the image 538 rendered at the second display 112 are not rendered at a respective display integrated with the robot device 803. Furthermore, the image 538 does not match a live image 835 of the operator 827. Hence, the user 528 may operate the computing device 659 to transmit a warning 860 that both the first display 111 and the second display 112 are not simultaneously rendering the same identifier 628 and/or the current token 628-2. The apparatus 101 may receive the warning 860 and transmit an instruction 870 to the computing device 659 and the robot device 103 to not proceed with the meeting. In some examples, when the instruction 870 is received, the apparatus 101 may end the meeting, for example, by controlling the robot device 103 (e.g. via the robot service device 525) to stop obtaining audio and/or video. Furthermore, the apparatus 101 may implement a remedial action, such as electronically alerting the operator 527 and/or a security service of the warning 860 such that a security action may occur to isolate and/or capture at least the robot device 803. For example, a security guard may be dispatched to the location 130.

It should be recognized that features and aspects of the various examples provided above may be combined into further examples that also fall within the scope of the present disclosure.

1. An apparatus comprising:
a network interface to communicate with: a first display integrated with a robot device; and a second display at a location of a meeting;
a memory identifying: a start time of the meeting; and the location of the meeting; and
a processor connected to the network interface and the memory, the processor to execute instructions stored in the memory, the instructions to: when the robot device is at the location of the meeting, and at the start time, transmit, using the network interface, an identifier associated with the meeting to both the first display integrated with the robot device and the second display at the location of the meeting, thereby causing both the first display and the second display to simultaneously render the identifier.

2. The apparatus of claim 1, wherein the identifier comprises one or more of a token generated for the meeting; an alphanumeric identifier of the meeting; an alphanumeric identifier of a room associated with the meeting; a graphic identifier of the meeting; an image of an operator of the robot device; and a name badge of the operator of the robot device.

3. The apparatus of claim 1, wherein the instructions are further to: transmit, using the network interface, an image of an operator of the robot device to the first display at the robot device, thereby causing the first display at the robot device to render the image of the operator of the robot device with the identifier.

4. The apparatus of claim 1, wherein the instructions are further to: for a duration of the meeting, periodically generate a current identifier associated with the meeting and periodically transmit, using the network interface, the current identifier to the first display and the second display, thereby causing both the first display and the second display to replace rendering of a previous identifier with the current identifier.

5. The apparatus of claim 1, wherein the memory further identifies an end time of the meeting, and the instructions are further to: at the end time, transmit, using the network interface, an instruction to the first display and the second display to stop rendering of the identifier or a current identifier.

6. A non-transitory machine-readable storage medium encoded with instructions executable by a processor, the non-transitory machine-readable storage medium comprising:
instructions to: determine when a robot device is at a location of a meeting;
instructions to: determine when a start time of the meeting occurs; and
instructions to: when the robot device is at the location of the meeting, and at the start time, transmit an identifier associated with the meeting to both a first display integrated with the robot device and a second display at the location of the meeting, thereby causing both the first display and the second display to simultaneously render the identifier.

7. The non-transitory machine-readable storage medium of claim 6, wherein the identifier comprises one or more of a token generated for the meeting; an alphanumeric identifier of the meeting; an alphanumeric identifier of a room associated with the meeting; a graphic identifier of the meeting; an image of an operator of the robot device; and a name badge of the operator of the robot device.

8. The non-transitory machine-readable storage medium of claim 6, further comprising instructions to: transmit an image of an operator of the robot device to the first display at the robot device, thereby causing the first display at the robot device to render the image of the operator of the robot device with the identifier.

9. The non-transitory machine-readable storage medium of claim 6, further comprising instructions to: for a duration of the meeting, periodically generate a current identifier associated with the meeting and periodically transmit, the current identifier to the first display and the second display, thereby causing both the first display and the second display to replace rendering of a previous identifier with the current identifier.

10. The non-transitory machine-readable storage medium of claim 6, further comprising instructions to: at an end time of the meeting, transmit an instruction to the first display and the second display to stop rendering of the identifier or a current identifier.

11. An apparatus comprising:
a network interface to communicate with: a first display integrated with a robot device; and a second display at a location of a meeting;
a memory identifying: a duration of the meeting; and the location of the meeting; and
a processor connected to the network interface and the memory, the processor to execute instructions stored in the memory, the instructions to:
when the robot device is at the location of the meeting, and when the meeting begins, for the duration of the meeting:
periodically generate a current token for the meeting; and
transmit, using the network interface, the current token to both the first display integrated with the robot device and the second display at the location of the meeting thereby causing both the first display and the second display to one or more of: render the current token; and replace rendering of a previous token with the current token.

12. The apparatus of claim 11, wherein the current token comprises one or more of: an alphanumeric identifier of the meeting; the alphanumeric identifier added to a prefix string or a suffix strong; and a graphic identifier of the meeting.

13. The apparatus of claim 11, wherein the instructions are further to: transmit, using the network interface, an image of an operator of the robot device to the first display at the robot device, thereby causing the first display at the robot device to render the image of the operator of the robot device with the current token.

14. The apparatus of claim 11, wherein the instructions are further to: receive, from a computing device associated with the second display at the location of the meeting, a confirmation that both the first display and the second display are simultaneously rendering the current token; and transmit an instruction to the computing device and the robot device to proceed with the meeting.

15. The apparatus of claim 11, wherein the instructions are further to: receive, from a computing device associated with the second display at the location of the meeting, a warning that the first display and the second display are not simultaneously rendering the current token; and transmit an instruction to the computing device and the robot device to not proceed with the meeting.
